(19) United States
(12) Patent Application Publication
(10) Pub. No.: US 2006/0019224 A1
(43) Pub. Date: Jan. 26, 2006

(54) Insomnia assessment and treatment device and method

(75) Inventors: Albert Behar, Reston, VA (US); William T. Riley, Ashburn, VA (US)

Correspondence Address: NIXON & VANDERHYE, PC, 901 NORTH GLEBE ROAD, 11TH FLOOR, ARLINGTON, VA, 22203, US

(73) Assignee: PICS, Inc., Reston, VA (US)

(21) Appl. No.: 10/897,035

(22) Filed: Jul. 23, 2004

(51) Int. Cl. G09B 19/00

(52) U.S. Cl. 434/236

(57) ABSTRACT

A method of automated sleep behavior modification for insomnia and other sleep problems using a computerized treatment system including: determining a baseline sleep pattern of a user and storing in the system data indicative of the baseline sleep pattern; generating a sleep behavior regimen based on the stored sleep pattern data and a behavior modification algorithm, wherein the algorithm generates sleep inducement behavior prompts; prompting the user to perform a predetermined sleep inducement behavior at a time determined by the regimen; tracking the sleep behavior of the user and storing data indicative of the tracked sleep behavior; modifying the regimen based on the tracked sleep behavior, and prompting the user to perform the predetermined sleep inducement behavior at a time determined by the modified regimen.

### BACKGROUND OF THE INVENTION

The present invention relates to an insomnia assessment and treatment device (IATD) and method that adapts behavioral principles to assist patients suffering from insomnia.

Insomnia affects approximately 30 million people in the U.S. Few patients suffering from insomnia seek medical treatment from a health professional. Those who consult with a physician often receive treatments, such as drug medications, that have minimal long-term efficacy and sometimes exacerbate insomnia. There is a need for a system to treat insomnia that has long-term efficacy and may be used by patients regardless of whether they seek medical treatment from a health professional.

Conventional insomnia therapy typically involves a sleep assessment and an insomnia treatment. Sleep assessments determine the sleep patterns and sleep periods of a patient. Using a sleep assessment, a health professional typically prescribes an insomnia treatment that may include drugs, sleep aid devices, and/or behavior therapy.

Sleep assessment types include polysomnography and actigraphy. During polysomnography, EEG (brain waves), EMG (muscle movement as in restless leg syndrome), respiratory functions (for sleep apnea) and ocular movement (rapid eye movement or REM) of a patient are measured and analyzed by a computer and interpreted by trained sleep technicians or health professionals. Actigraphy is another common sleep assessment treatment that measures the asleep and awake states of a patient. Actigraph accelerometers, usually worn on the wrist of the patient, monitor the amount of physical activity of the patient. Based on the data collected from the accelerometers, the sleep periods of the patient may be measured by differentiating between the level of movement usually associated with wake states and sleep states. Actigraphy may be combined with other physiological monitoring, e.g., body temperature and galvanic skin response, to improve the accuracy of sleep monitoring.

Another sleep assessment technique is the use of sleep tracking devices, such as a “dead man's switch”, to detect when a patient falls asleep. These tracking devices include a switch-activated clock started by the release of a dead-man's switch which the patient grasps when they go to bed and releases when they fall asleep. The release of the switch indicates that the patient is asleep and starts a timer in the sleep tracking device. Upon awakening, the patient records the elapsed time that he is asleep. The elapsed time may be displayed by the sleep tracking device. Exemplary sleep tracking devices using dead man's switches are disclosed in U.S. Pat. Nos. 6,392,962 and 6,078,549.

Active sampling is another sleep assessment technique. Sampling involves periodically prompting a patient to respond to determine if the patient is asleep.

An exemplary active sleep sampling device was developed by Lichstein and colleagues (Kelley & Lichstein, 1980) as the Sleep Assessment Device (SAD) which produced a short, low volume tone every 10 minutes throughout the night which the subject verbally acknowledges by stating “I'm awake” into a tape player. A health professional would later listen to the tape and manually record the response of the patient to each prompt. When the patient did not respond to the prompt, it was presumed that he/she was asleep. This sampling procedure was not found to be disruptive to the sleep of the insomnia patients. Sleep sampling has been found to be reliable for assessing sleep patterns.

The treatments for insomnia are pharmacologic and behavioral. Medical treatments include homeopathic remedies (e.g. melatonin), over the counter (OTC) non-prescription medications (diphenhydramine, Unisom) and prescribed medications (Ambien). A range of peripheral products have been developed to provide an environment conducive to sleep. They include: sleep aids such as pillows that cool the patient, white noise generators and relaxing music players. In addition, electronic sleep aid products include an acupuncture device called “Alpha-Stim SCS” which emits small electrical currents to the ear lobe and induces relaxation and sleep, and a magnetic field generator which supposedly induces sleep (low energy emission therapy).

Behavioral treatments for insomnia include training sleep hygiene (e.g. wind down time to relax before going to bed), cognitive restructuring (e.g. break the cycle of trying so hard to sleep that you become tense and unable to sleep), relaxation training, stimulus control (associate getting into bed with falling asleep) and sleep restriction (cut back on time in bed and gradually shape sleep behavior). These behavioral treatments have typically been delivered by health professionals with expertise in insomnia. Books such as Peter Hauri's “No More Sleepless Nights” and Charles Morin's “Relief From Insomnia: Getting the Sleep of Your Dreams” provide these behavioral sleep strategies in a self-help form.

Many who have researched self-help insomnia treatments suggest that some of the most efficacious components of the treatment, i.e., stimulus control and sleep restriction, are difficult to teach to patients and to assure compliance by the patients. Accordingly, there is a long felt need for sleep assessments techniques and insomnia treatments, especially those that teach and monitor compliance of stimulus control, sleep restriction and other insomnia treatment components.

### BRIEF DESCRIPTION OF THE INVENTION

In one embodiment, the invention is a method for automated sleep behavior modification using a computerized treatment system comprising: determining a baseline sleep pattern of a user and storing in the system data indicative of the baseline sleep pattern; generating a sleep behavior regimen based on the stored sleep pattern data and a behavior modification algorithm, wherein the algorithm generates behavior prompts; prompting the user to perform a predetermined sleep inducement behavior at a time determined by the regimen; tracking a sleep behavior of the user and storing data indicative of the tracked sleep behavior; modifying the regimen based on the tracked sleep behavior, and prompting the user to perform the predetermined sleep inducement behavior at a time determined by the modified regimen.

In another embodiment, the invention is a method for insomnia assessment and treatment comprising: assessing a sleep pattern of a user and storing data regarding the sleep pattern and generating a regimen to improve sleep; prompting the user to perform the sleep inducement behaviors as prescribed by the regimen, and tracking the sleep pattern of the user and storing data regarding the tracked sleep pattern; modifying the sleep inducement regimen based on the tracked sleep pattern, and prompting the user to perform a predetermined sleep inducement behavior prescribed by the modified regimen.

In a further embodiment, the invention is a method for sleep behavior modification using a computerized treatment system comprising: storing sleep pattern data in memory of the treatment system; generating a sleep behavior regimen based on the stored sleep behavior data and a behavior modification algorithm, wherein the algorithm generates sleep behavior prompts; said sleep behavior prompts for getting in or out of bed based on prior sleep time, awake time, and sleep efficiency; prompting the patient to perform a predetermined sleep inducement behavior at a time determined by the treatment system; tracking sleep behavior of the user and storing data indicative of the tracked sleep behavior; modifying the regimen based on the tracked sleep behavior, and prompting the user to perform the predetermined sleep behavior at a time determined by the modified regimen.

Moreover, the invention may also be embodied as a method of assessing a sleep behavior pattern of a user operating a computer controlled treatment device, said method comprising: the device actively sampling the user to periodically determine whether the user is awake or asleep; the device automatically collecting data indicative of whether the user is awake or asleep during the active sampling, and determining a sleep behavior pattern of the user based on the collected data.

In a further embodiment, the invention is a device for assisting a user to adjust a sleep behavior, said device comprising: a processor and a storage device, wherein an executable program and sleep pattern data are stored in the storage device, and the processor executes said executable program to generate a sleep regimen based on the sleep pattern data; a user prompt activated by the processor, wherein the processor activates the prompt in accordance with the sleep regimen to prompt the user to perform the sleep behavior, and an input activated by the user to indicate when the prompted sleep behavior is performed.

### BRIEF DESCRIPTION OF THE DRAWINGS

FIG. 1 is a diagram of a patient in a bed using an insomnia assessment and treatment device (IATD) device.

FIG. 2 is a flow chart of steps to be performed to assess and treat insomnia.

FIG. 3 a front view of the IATD showing the user interface of the device.

FIG. 4 is a schematic block diagram of the electronic components of the IATD.

### DETAILED DESCRIPTION OF THE INVENTION

An Insomnia Assessment and Treatment Device (IATD) has been developed. In various embodiments, the IATD may be used to provide computerized or automated sleep assessments, and sleep behavioral treatment, such as nonpharmacologic treatment or psychosocial treatment of insomnia. The IATD is configured to assist a user to follow regimens for insomnia assessment and treatment that have been automated and embodied in the IATD device. For example, the IATD may automatically and continually assess the sleep behavior of a patient, produce prompts to train the user to get out of bed if not asleep within a specified period (which is stimulus control), and signal the user when to go to bed or wake up (which is sleep restriction). The program(s) implemented by the IATD is based on established and scientifically supported sleep assessments and behavioral strategies using stimulus control and sleep restriction. The user may use the IATD as a self-help insomnia program or under the guidance of a physician or other heath care professional.

Insomnia is typically defined as one or more months of complaints of difficulty initiating or maintaining sleep or non-restorative sleep which causes distress or impairs normal functioning of a patient. The diagnosis of insomnia is subjective. Insomnia does not easily fit into a simple definition. Primary insomnia (also referred to as psychophysiological insomnia) is insomnia that is not due to another condition such as sleep apnea, pain or depression. The IATD disclosed herein is most helpful in treating primary insomnia, but may also be applicable in treating other types of insomnia (especially when combined with other treatments for apnea, pain, depression or other contributing condition).

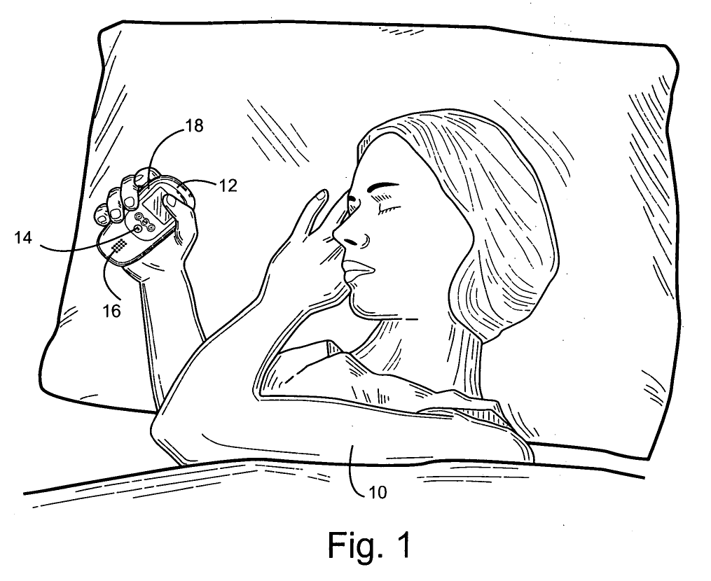

FIG. 1 is a diagram of a user 10 in a bed using an IATD 12. The user lies in her bed in a normal fashion and prepares to go to sleep. Upon entering her bed, the user presses a “bed” key 14 on the IATD. The IATD records the time when she enters her bed. The user, while laying in bed, holds the IATD instrument 12 in her hand. A strap may secure the IATD instrument to the hand.

The IATD 12 may use an active sampling technique to track sleep behavior. Active sampling may be the IATD periodically, e.g., every ten minutes, prompting the user to determine if she is awake or asleep. The IATD 12 may audibly prompt the user by emitting a sound through a speaker 16. When prompted, the user activates the awake bar 18. If the user does not activate the bar 18 within a predetermined period, e.g. ten seconds, the IATD 12 assumes that the user is asleep. The IATD records the time of the prompt (or when the bar is pressed) and whether the awake bar is depressed as an indication of the user being awake or asleep.

The audible prompt may be a low tone, low volume pulse sound emitted periodically, e.g., every ten minutes. This pulse sound is not disruptive to sleep but can be heard by the patient if awake. As an alternative to or in addition to the audible prompt, the IATD device may emit a light prompt, may vibrate or otherwise prompt the user to respond if awake. If the user is asleep, the prompt is sufficiently quiet and subtle so as not to disturb the sleep state.

The response by the user to the IATD may be depressing the awake bar 18, or by a verbal response or by general movement (such as shaking an actigraph in response to a prompt). Moreover, the user's response to the IATD may be voluntary or involuntary depending on sleep sensing probe or prompt. Based on the user's response or lack of a response, the IATD automatically determines awake or asleep states.

Regardless of whether the user depresses the awake bar, the IATD may continue to sample sleep by emitting the audible prompt periodically. By sampling, the IATD determines approximately the periods of the user's awake state and/or asleep state while in bed. Active sampling enables the IATD to collect data regarding the period that a user lies awake in bed until she falls asleep and any subsequent awake periods while in bed. The device 12 also collects data on the period(s) that the patient is asleep. By active sampling, the IATD collects data regarding the patient's sleep behavior. These data are collected so that the IATD can assess sleep patterns.

The IATD stores the timing of each prompt and whether the user responded to the prompt. The stored time and response data are later analyzed by the IATD to assess the sleep pattern of a user. For example, the data are used to determine approximately the period between when a patient enters the bed and falls asleep, the period(s) of sleep, the number and length of awakenings during the night, and when the user gets out of bed.

The user indicates to the IATD when she is in or out of bed either via key 14, by docking the IATD into cradle, and/or pressing or releasing a pressure pad. The IATD provides automatic and immediate computation each morning of relevant sleep variables such as total time in bed, total time asleep, sleep onset latency (time from initial in bed to asleep), and sleep efficiency (time asleep/time in bed) with feedback to the user about these variables each morning.

The core functions of the IATD 12 may include one or more of the following functions:

(i) Measurement of Asleep vs. Awake Periods.

While the user is in bed, active sleep sampling is employed to periodically prompt the patient to respond by pressing the awake bar 18 if she is still awake. The prompt may be a regularly scheduled low tone, low volume beep (sleep tone) emitted by the device. Absence of a response, e.g., the bar 18 is not pressed, is assumed to indicate that the patient is asleep. By periodically repeating the sleep tone, e.g., every 10 minutes, the device 12 may track the sleep period(s) of the patient and determine how often the patient awakens during the night. As an alternative to active sampling, sleep periods may measured by a “dead man's switch” in which a button is held by the user when they go to bed and released when they fall asleep.

(ii) Sleep Restriction.

The IATD sets a regular wake time or allows a user to set a regular wake time. The regular wake time may be a certain time of day, e.g., 8:00 am, or after a regular sleep period, e.g., eight hours of sleep. The IATD emits alarms, e.g., an audible alarm 16, sufficient to cause the user to wake up at a prescribed awake time. Awakening the patient at a prescribed wake time avoids excessive sleep, which can contribute to difficulty falling asleep the next night. The IATD may also emit a prompt at a time scheduled to go to bed. This bedtime prompt encourages the user to restrict the amount of time in bed. The bedtime prompt may be automatically determined by the IATD based on the assessed time asleep from a prior night(s).

(iii) Stimulus Control.

The IATD trains a user to fall asleep in response to getting in bed. The IATD prompts the patient to get out of bed if she is not asleep within 20 minutes, for example. Prompting the user to get out of bed provides sleep stimulus control. The stimulus is the act of getting into bed. The desired response to this stimulus is that the patient falls asleep shortly after getting into bed. If she does not quickly fall asleep, the stimulus of getting into bed is being associated with not sleeping so she is prompted to get out of bed to break this association. The user may be instructed not to return to bed until after a period of time, e.g., 15 minutes, has passed or the patient is sleepy. When the user returns to bed, the stimulus period is restarted and the IATD 12 resumes active sampling to check whether she falls asleep within 20 minutes. This process of getting into bed, attempting to fall asleep in 20 minutes, getting out of bed after 20 minutes if not asleep, and repeating the process is sleep stimulus control training. Training modifies the behavior of the user such that she will respond to the stimulus of getting into bed by falling asleep.

(iv) The IATD adjusts the bed time based on the user's sleep efficiency (the ratio of time asleep/time in bed) and gradually shapes the sleep behavior of the patient to a regular and normal sleep pattern. The IATD shapes the sleep behavior by scheduling and prompting bedtime and gradually making this bedtime earlier or later based on the patient's sleep efficiency. A high sleep efficiency results when the patient is asleep during the vast majority of time that she is in bed. It is desirable that the efficiency be high such that the vast majority of time in bed is asleep time.

The IATD provides computerized and automated delivery of sleep restriction for insomnia by use of active sampling (signaling to check if awake) of sleep to compute (automated via a computer device 12) daily sleep variables that can be identified and, the IATD can provide immediate feedback to patient each morning. The IATD uses active or passive behavioral sleep sampling to automatically produce and adjust the behavioral insomnia treatments programmed into the IATD, e.g., a prescribed bedtime each night. The IATD also provides computerized and automated delivery of stimulus control for insomnia. Further, the IATD provides the ability to provide continuous collection of data for sleep assessments which can be used to track changes in the sleep behavior of a patient that, for example, result from the sleep stimulus and sleep restriction regimens generated by the IATD for the user. Further, the IATD can adjust the sleep stimulus and sleep restriction regimens based on new data collected from the ongoing sleep data collected by the sleep assessment operation of the IATD.

The IATD shown in FIG. 1 is a dedicated handheld electronic device. The IATD may also be implemented, for example, on a desktop computer, a personal digital assistant (PDA), a smart phone or an Internet web program in which a patient self-reports information from the night before and the web program sets up the next day's sleep schedule for the patient based on the entered data and sleep assessment algorithms.

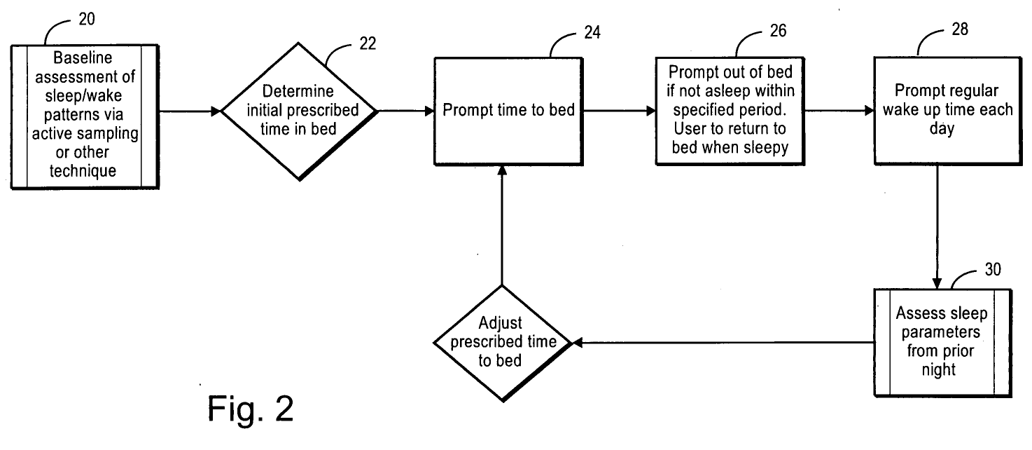

FIG. 2 is a flow chart of a method to assess the sleep behavior of a user and to automatically prescribe behavioral treatments, to alleviate insomnia and restore normal sleep. The sleep and awake states, as well as associated sleep variables, are determined in an automated fashion by the IATD. The IATD automatically assesses asleep and awake states by recording responses of the user to a periodic prompt and storing that data in ROM.

Based on initial baseline sleep data 20, the IATD determines the following to design a tailored insomnia treatment approach that may assess or set one or more of the following: a) total time in bed, b) bedtime, c) sleep onset latency (which is the approximate period from when the user enters her bed and falls asleep), d) morning awake times, e) total sleep time (which may be approximated based on the response by the user to the periodic prompts), and f) sleep efficiency (which is the ratio of the approximate period that the user is asleep to the period that the user is in bed).

The IATD encourages the user to set a morning awake time with minimal variability (consistent wake up time) and prompts the user out of bed each morning (alarm clock function) at the awake time, in step 28. The IATD sets the time to bed each night based on prior sleep data and may display this time to the user on the IATD display screen 19. Initially, bedtime is set based on morning awake time and mean total sleep time. For example, if the user sleeps an average of six hours and the wake up time is 7:00 am, the IATD sets the bedtime for the next night for 1:00 am.

The IATD prompts the user to go to bed (auditory and visual display) at the time it determines based on the wake time and sleep assessment data, in step 24. If the user is not asleep within a specified time (e.g., 20-30 minutes), the IATD prompts her to get out of bed for a period of time before retrying to go to sleep (auditory and visual display) in step 26.

The IATD continues to assess the sleep time each night using methods specified above, e.g., active sampling, and adjusts the time to bed each night based on sleep efficiency from prior nights in step 30. High sleep efficiencies (e.g., greater than 85-90%) result in an earlier prescribed bedtime and low sleep efficiencies (<80%) result in a later prescribed bedtime. Accordingly, the bedtime may be automatically determined by the IATD based solely or in part on the sleep efficiency of the prior night(s) sleep.

The user indicates to the IATD when sleep is satisfactory. At that time, the user can switch the IATD to a “maintenance mode” which will continue to assess sleep and prompt her to get in and out of bed at prescribed times. In maintenance mode, the IATD does not make further adjustments to the sleep schedule (unless the sleep behavior worsens).

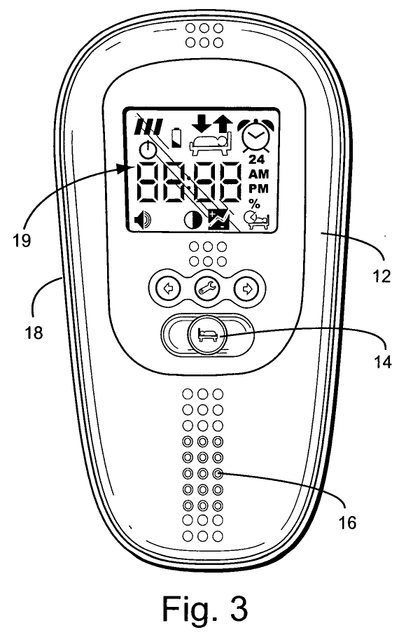

FIG. 3 is a front view of a hand held IATD 12. The device includes a display, user input buttons and an audio speaker 16. Housed within the device are a computer processor and other electronics for operating the device. The IATD 12, fits easily in the palm of a hand of a user. The device may have minimal buttons and other user interface features to simplify its operation. For example, the primary user inputs may be a one large key bar 18 for responding to a prompt of the machine as to whether the user is awake or not, and a smaller “In Bed” button 14 for use when the user has entered the bed or gotten out of bed. The other buttons may be relatively small so as to avoid any tendency of the user hitting the wrong button when in a half asleep state.

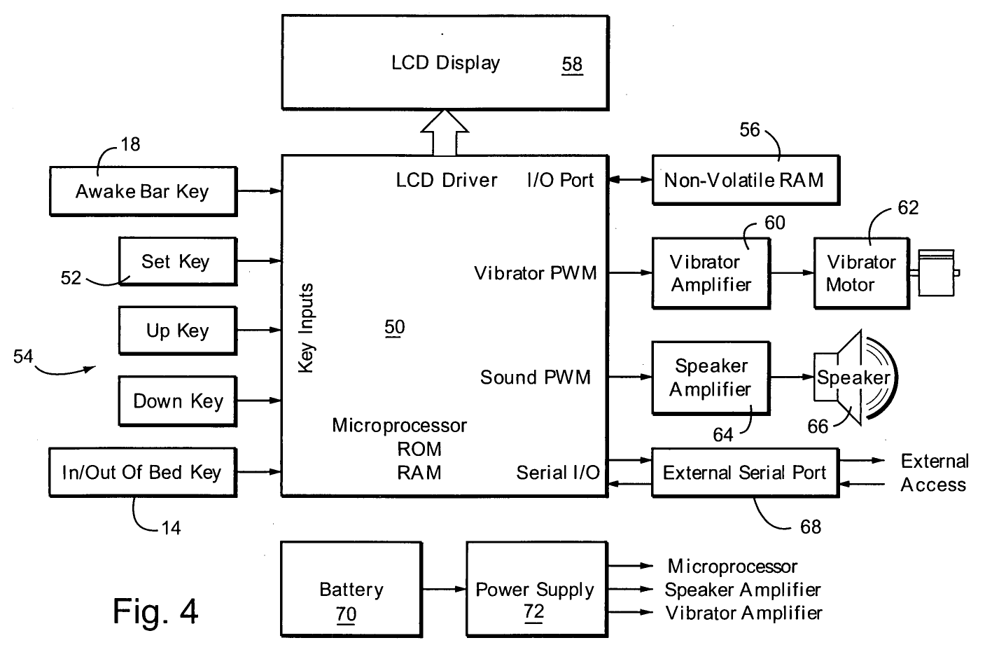

FIG. 4 is an electronic schematic diagram of the computer processor and other electronics within the IATD 12. The processor 50 may be a conventional microprocessor having internal read only memory (ROM) and random access memory (RAM). The processor includes data and command inputs from the various keys on the device, such as the awake bar 18, in/out of bed key 14, a control set key 52, and up and down keys. These operator inputs are used by the user to enter data and user selections into the microprocessor.

The microprocessor executes a program stored in its ROM and/or the non-volatile RAM 56. The program may implement the method for sleep assessment and insomnia treatment, such as shown in FIG. 2.

The processor 50 drives a liquid crystal display 58 which provides information to the patient regarding the operation of the device, the recorded sleep data and the sleep regimen. In addition, the processor may, when appropriate, activate a vibrational amplifier 60 and vibrator motor 62 to prompt the user to perform a certain act, such as to get out of bed or press the key bar 18. Similarly, the processor may output a sound to a speaker amplifier 64 and speaker 66 to audibly prompt the patient. Further, the processor may have an external serial port 68 to allow an external device, such as a computer, to interrogate data on the device and otherwise exchange data and control information with the device.

To power the device, a standard battery 70 powers a power supply 72 in the device which provides power to the microprocessor, speaker amplifier and vibrator amplifier. Further, the devices may include a non-volatile memory which permanently stores the executable programs of the device and does not allow erasure of the programs when the battery expires or is replaced.

The processor 50 and the algorithm programs and sleep data stored in its associated memory ROM, RAM and non-volatile RAM 56 provide the logic to perform sleep assessments, automatically generate a sleep modification behavior regimen and analyze data regarding sleep behaviors to determine if and when the regimen should be modified. This logic may in other embodiments be implemented in other devices, such as personal computers; personal digital assistants (PDAs); smart cell or wired telephones (where “smart” refers to processors in the telephone or another device in communication with the telephone that enable users or manufacturers to embed functions such as an IATD program), and smart televisions, digital alarm clocks and other consumer electronic products. Further, the IATD logic functions may be on a central computer system that a user interacts with over, for example, a telephone connection or Internet website communication link.

By way of example, the logic means on a remote computer system may be accessible to a user via an Internet website that collects user information such as patient identification, and user baseline sleep behavior. The information collected from the user may be manually entered to the website or automatically entered by a monitoring device, such as a hand-held device, user movement sensor or other device that tracks sleep behavior. The monitoring device transmits, via a wired or wireless link, sleep behavior information to a data entry device, such as a personal computer or PDA, that enters data to the website of the IATD logic means. The IATD logic means applies the sleep behavioral algorithms, such as shown in FIG. 2, to automatically generate a sleep inducement regimen.

The sleep inducement regimen is initially generated using baseline sleep behavior data that are manually entered by the user and/or based on sleep behavior data collected by a monitoring device. For example, the user may enter in information regarding his or her age, sex, desired wake up time and times in bed and asleep for each of the seven days of the week or a monitoring device collects sleep behavior data from one or more nights sleep (before a sleep inducement behavior regimen is generated). The regimen may be modified based on, for example, sleep data collected during one or more prior nights of sleep. The regimen prescribes sleep inducement behaviors, such as what time to go to bed and how long to lay awake in bed before getting out of bed. The website outputs prompts for the prescribed sleep inducement behavior, such as a “go to bed” prompt and a “get out of bed” prompt. The prompts are transmitted from the website via the Internet to the patient's personal computer, PDA, telephone or the like which issues the prompt to the patient; or tailored instructions for self-prompting of the next night's sleep could be provided to the user.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method for automated sleep behavior modification using a computerized treatment system comprising:
a. determining a baseline sleep pattern of a user and storing in the system data indicative of the baseline sleep pattern;
b. generating a sleep behavior regimen based on the stored sleep pattern data and a behavior modification algorithm, wherein the algorithm generates behavior prompts;
c. prompting the user to perform a predetermined sleep inducement behavior at a time determined by the regimen;
d. tracking a sleep behavior of the user and storing data indicative of the tracked sleep behavior;
e. modifying the regimen based on the tracked sleep behavior, and
f. prompting the user to perform the predetermined sleep inducement behavior at a time determined by the modified regimen.

2. A method as in claim 1 wherein the predetermined sleep inducement behavior is prompting a prescribed bedtime and wake-up time.

3. A method as in claim 2, wherein prompting the sleep inducement behavior comprises prompting the user to get out of bed if the user does not fall asleep within a predetermined time after getting into bed.

4. A method as in claim 1 wherein the system comprises an insomnia assessment and treatment device (IATD) and the IATD comprises a processor, a user interface and a memory and said method further comprises the IATD automatically recording sleep behavior data the sleep pattern by recording the sleep behavior of the user, and storing the sleep behavior data in memory.

5. A method as in claim 1 wherein data regarding the baseline sleep pattern data are collected by monitoring the user during at least one sleep period.

6. A method as in claim 1 wherein data regarding the baseline sleep pattern data are collected by tracking a response of the user to a series of sleep behavior prompts periodically issued throughout a sleep period.

7. A method as in claim 1 wherein data regarding the baseline sleep pattern data are collected by determining when the user releases a dead man's switch.

8. A method as in claim 1 wherein data regarding the baseline sleep pattern data are collected by actively sampling responses of a user to a series of sleep behavior prompts given while the user is in bed.

9. A method as in claim 1 wherein data regarding the baseline sleep pattern data comprises baseline sleep data manually entered into the system.

10. A method as in claim 1 further comprising maintaining the regimen for a period without further modification after a desired sleep behavior has been achieved.

11. A method for insomnia assessment and treatment comprising:
a. assessing a sleep pattern of a user and storing data regarding the sleep pattern and generating a sleep regimen;
b. prompting the user to perform the sleep inducement behaviors as prescribed by the regimen, and
c. tracking the sleep pattern of the user after step (b) and storing data regarding the tracked sleep pattern;
d. modifying the sleep inducement regimen based on the tracked sleep pattern, and
e. prompting the user to perform a predetermined sleep inducement behavior prescribed by the modified regimen.

12. A method as in claim 11 wherein the predetermined sleep behavior is the time the patient gets into bed.

13. A method as in claim 11 wherein an insomnia assessment and treatment device (IATD) comprises a processor, a user interface and a memory and said method further comprises the IATD automatically recording sleep behavior data, the sleep pattern by recording the sleep behavior of the user, and storing the sleep behavior data in the memory.

14. A method as in claim 11 wherein assessing the sleep pattern comprises monitoring the user's sleep for a period of time.

15. A method as in claim 11 wherein assessing the sleep pattern comprises periodically prompting the user to respond if awake and tracking the response of the user.

16. A method as in claim 11 wherein assessing the sleep pattern comprises monitoring when the user releases a dead man's switch.

17. A method as in claim 11 wherein assessing the sleep pattern comprises actively sampling responses of a user to a series of prompts given while the user is in bed.

18. A method as in claim 11 wherein the sleep pattern assessment comprises baseline sleep data manually entered into the system.

19. A method as in claim 11 further comprising maintaining the modified regimen for a period without further modification after a desired sleep behavior has been achieved.

20. A method for sleep behavior modification using a computerized treatment system comprising:
a. storing sleep pattern data in the memory of the treatment system;
b. generating a sleep behavior regimen based on the stored sleep behavior data and a behavior modification algorithm, wherein the algorithm generates sleep behavior prompts; said sleep behavior prompts for getting in or out of bed based on prior sleep time, awake time, and sleep efficiency;
c. prompting the patient to perform a predetermined sleep inducement behavior at a time determined by the treatment system;
d. after step c, tracking sleep behavior of the user and storing data indicative of the tracked sleep behavior;
e. modifying the regimen based on the tracked sleep behavior, and
f. prompting the user to perform the predetermined sleep behavior at a time determined by the modified regimen.

21. A method as in claim 20 wherein the stored sleep behavior data are collected by monitoring a user's sleep for a period of time.

22. A method as in claim 20 wherein the stored sleep behavior data are collected by prompting the user to respond if awake to a prompt; or responds involuntarily or physiologically to a prompt.

23. A method as in claim 20 wherein the stored sleep behavior data is collected by monitoring when the user releases a dead man's switch.

24. A method as in claim 20 wherein the stored sleep behavior data is collected by actively sampling responses to a user to a series of prompts given while the patient is in bed.

25. A method as in claim 20 wherein the stored sleep behavior comprises baseline sleep data manually entered into the system.

26. A method as in claim 20 further comprising maintaining the regimen for a period without further modification after desired sleep behavior has been achieved.

27. A method of assessing a sleep behavior pattern of a user operating a computer controlled treatment device, said method comprising:
a. the device active sampling the user to periodically determine whether the user is awake or asleep;
b. the device automatically collecting data indicative of whether the user is awake or asleep during the active sampling, and
c. determining a sleep behavior pattern of the user based on the collected data.

28. The method as in claim 27 wherein the step of active sampling comprises periodically prompting the user to respond if awake, and the step of automatic collecting comprises the device recording as the data the responses and lack of responses to the prompts.

29. The method as in claim 28 wherein the step of active sampling comprises periodically issuing a prompt to the user while the user is in bed and the step of automatically collecting data is recording whether the user responds to each prompt.

30. The method as in claim 29 wherein in the step of determining the sleep behavior the collected data are used to assess total sleep time of the user while in bed.

31. The method as in claim 29 wherein the collected data are used to assess sleep onset latency.

32. The method as in claim 29 wherein the collected data are used to assess sleep efficiency of the user.

33. The method as in claim 27 wherein the sleep behavior pattern is manually inputted into the device.

34. A device for assisting a user to adjust a sleep behavior, said device comprising:
a processor and a storage device, wherein an executable program and sleep pattern data are stored in the storage device, and the processor executes said executable program to generate a sleep regimen based on the sleep pattern data;
a user prompt activated by the processor, wherein the processor activates the prompt in accordance with the sleep regimen to prompt the user to perform the sleep behavior, and an input activated by the user to indicate when the prompted sleep behavior is performed.

35. The device as in claim 34 wherein the user prompt is a speaker issuing an audible signal.

36. The device as in claim 34 wherein the user input is a key actuated by the user.

37. The device as in claim 34 wherein the sleep behavior is a prescribed bedtime.

38. The device as in claim 34 further comprising a second input to receive a response by the user to a second prompt, wherein the second prompt is periodically generated by the processor to actively sample the sleep pattern of the user.
